(19) United States
(12) Patent Application Publication
(10) Pub. No.: US 2008/0316014 A1
(43) Pub. Date: Dec. 25, 2008

(54) System and a method for locating an individual

(76) Inventor: Keith C. Armstrong, Boca Raton, FL (US)

Correspondence Address: BLANK ROME LLP, 600 NEW HAMPSHIRE AVENUE, N.W., WASHINGTON, DC, 20037, US

(21) Appl. No.: 11/812,666

(22) Filed: Jun. 20, 2007

(51) Int. Cl. G08B 26/00

(52) U.S. Cl. 340/505

(57) ABSTRACT

A system for locating an individual includes a chip with a unique code, a monitor with the unique code, a monitoring station in communication with the monitor, a satellite communication station in communication with the monitoring station, and satellites in communication with the satellite communication station. The chip is implantable in the individual. The satellites transmit a search signal over a search area of predetermined size. The search area is increased until the chip is located. The search signals from the satellites form triangulation data. Location data is formed from the triangulation data and transmitted to the monitor.

### FIELD OF THE INVENTION

The present invention relates to locating systems. In particular, the present invention relates to a system for locating an individual using an implantable chip and satellites to determine the position of the chip.

### BACKGROUND OF THE INVENTION

The ability to locate and track an individual can be vital and crucial. For instance, approximately 800,000 children are reported missing in the United States every year. As the population increases, more children are expected to be reported missing. Another example involves individuals traveling abroad. In politically volatile regions of the world, individuals, such as businessmen and contractors, are susceptible to kidnapping and may be held hostage for ransom. Finally, soldiers in hostile territory could be captured and held secretly.

As a result, many systems for tracking and locating individuals have been developed. However, the approach of prior systems or methods have drawbacks. Certain prior systems and methods are designed to locate an individual only within a limited area, such as U.S. Pat. No. 6,700,493 to Robinson, entitled “Method, Apparatus and System for Tracking, Locating and Monitoring an Object or Individual.” Other systems and methods are expensive because specifically-built components must be used with the system or method, such as U.S. Pat. No. 6,031,460 to Banks, entitled “Child Locating System.”

Thus, there is a need for a locating system and method that operates over an expansive area but is relatively inexpensive to manufacture because it uses readily available components. Although several different systems and methods have been proposed, it can be appreciated that there exists a continuing need for a new and improved system and method for locating an individual.

### SUMMARY OF THE INVENTION

Accordingly, it is an aspect of the present invention to provide a system and a method for locating an individual that operates over an expansive area and uses readily available components.

One embodiment of the present invention provides a system for locating an individual. The system for locating the individual includes a chip with a unique code, a monitor with the unique code, a monitoring station in communication with the monitor, a satellite communication station in communication with the monitoring station, and satellites in communication with the satellite communication station. The chip is associated with the individual. The monitor transmits a locate signal with the unique code and receiving location data. The monitoring station receives the locate signal with the unique code and thereafter transmits a relayed locate signal with the unique code. The satellite communication station receives the relayed located signal with the unique code and thereafter transmits an initiate search signal with the unique code. The satellite communication station also forms the location data after receiving triangulation data and transmits the location data to the monitor. The satellites transmit a search signal upon receiving the initiate search command. The search signal is transmitted over a search area of predetermined size to locate the chip with the unique code received by the satellites, and the search area is increased until the chip is located. The search signals from the satellites form the triangulation data.

Another embodiment of the present invention provides a method of locating an individual. The method begins with assigning a unique code to a chip. Next, the chip is implanted in the individual. Next, a monitor is provided with the unique code. The monitor is capable of transmitting a locate signal with the unique code when a user wants to locate the individual. Next, a monitoring station is provided in communication with the monitor. The monitoring station transmits a relayed locate signal with the unique code after receiving the locate signal and the unique code. Next, a satellite communication station is provided. The satellite communication station is capable of transmitting an initiate search signal after receiving the relayed locate signal. Next, satellites are provided in communication with the satellite communication station. Each of the satellites is capable of transmitting a search signal after receiving the initiate search signal with the unique code. The search signal is transmitted over a search area of predetermined size to locate the chip with the unique code received by the satellites. Each of the satellites are programmed to increase the search area until the chip is located. Next, triangulation data is formed from the search signals. Then, location data is formed from the triangulation data, and the location data is transmitted to the monitor. Finally, the location data is displayed on the monitor.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic block diagram illustrating a system for locating an individual according to an embodiment of the present invention; and

FIG. 2 is a flow chart illustrating the steps of a method for locating an individual according to an embodiment of the present invention.

### DETAILED DESCRIPTION OF THE INVENTION

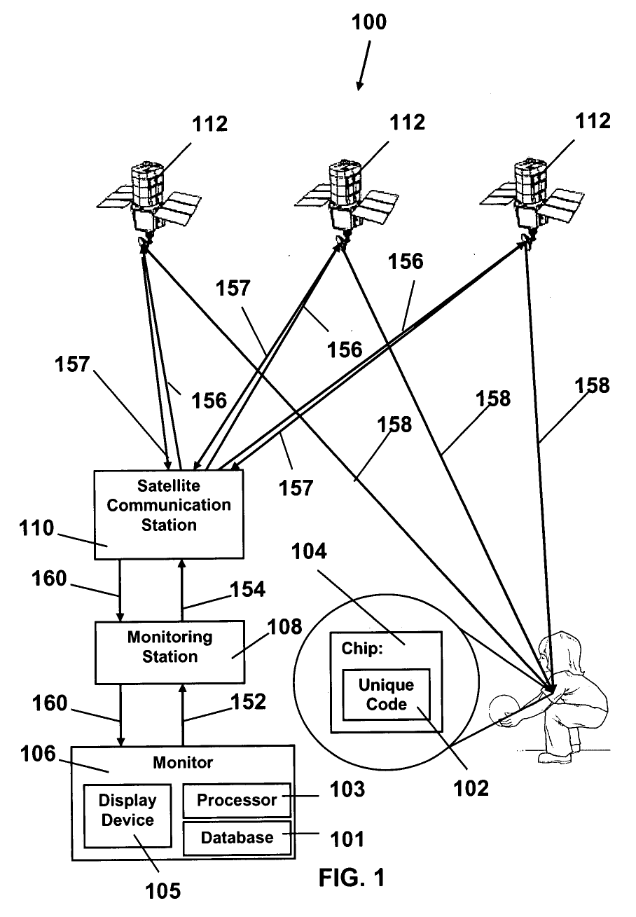

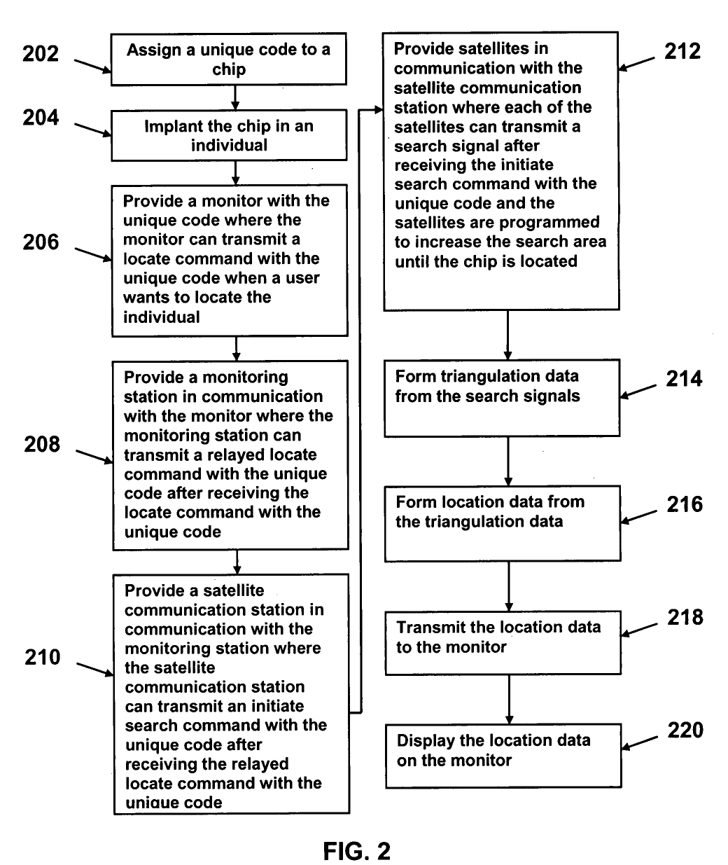

Referring to FIGS. 1 and 2, the present invention relates to a system and a method for locating an individual. The system and the method for locating the individual operates over an expansive area and uses readily available components.

Referring to FIG. 1, a schematic block diagram of the system 100 for locating the individual is shown. The system for locating an individual includes a unique code 102, a chip 104, a monitor 106, a monitoring station 108, a satellite communication station 110, and satellites 112.

The unique code 102 is electronically disposed on the chip 104. The unique code 102 may be an electronic code; a computer-recognizable code, such as binary, hexadecimal, or other similar computer codes; or any combination of the aforementioned. The unique code 102 may be programmed onto the chip 104, hardwired as part of the chip 104, or made electronically part of the chip 104 by other similar methods.

The chip 104 is preferably a sterilized implantable chip implanted into an individual. The individual who receives the chip 104 may be a child, a business executive, a contractor, a soldier, or anyone else who may become missing or be secretly held. Preferably, the chip 104 is implanted in the upper back of the arm or in the upper back of the individual and can later be removed. The chip 104 may be a semiconductor chip, a radio frequency identification chip, a transceiver, or some other similar device.

When a user wants the system 100 to locate the individual, the user uses the monitor 106. Preferably, the monitor 106 is portable, and more preferably, the monitor 106 is handheld. The unique code 102 is also electronically disposed in the monitor 106 such as by, but not limited to, programming onto the monitor 106, hardwired as part of the monitor 106, or made electronically part of the monitor 106 by other similar methods. When the user uses the monitor 106 to initiate the system 100, the monitor 106 transmits a locate signal 152 with the unique code 102 to the monitoring station 108. The monitor 106 can transmit the locate signal 152 with the unique code by electromagnetic signals, such as, but not limited to, radiofrequency waves or by cellular phone signals, such as, but not limited to, email, SMS message, EMS message, MMS message, and other similar signals. The locate signal 152 with the unique code are preferably transmitted by a cellular phone signal, such as, but not limited to short messaging service (“SMS”), enhanced messaging service (“EMS”), multimedia messaging service (“MMS”), email, or other similar cellular phone signals. When the monitor 106 is using cellular phone signals, the monitor 106 can be a cellular phone, personal digital assistant (“PDA”), email device, data transmitter, or other similar device using cellular phone signals. The monitor 106 can also include maps to display the location of the chip 104 implanted in the individual. In one embodiment, the monitor 106 can include a processor 103, a display device 105, and a database 101 with maps for displaying on the display device 105. Alternatively, the map can be provided to the monitor 106. The monitor 106 can be configured to receive an audio-visual file from a remote web server by email, MMS message, and other similar transmissions for providing map data. Preferably, the map can be electronically scrolled.

The monitoring station 108 is in communication with the monitor 106. The monitoring station 108 is preferably near the user or the monitor 106. The monitoring station 108 can be configured to receive the locate signal 152 from monitor 106 by email, SMS message, EMS message, MMS message, or other similar transmissions. The monitoring station 108 is preferably configured to receive the locate signal 152 by cellular phone signal. The monitoring station 108 is also in communication with the satellite communication station 110. Once the monitoring station 108 receives the locate signal 152 from the monitor 106, the monitoring station 108 transmits a relayed locate signal 154 with the unique code to the satellite communication station 110. The monitoring station 108 boosts the power of the locate signal 152 to form the relayed locate signal 154. The monitoring station 108 boosts the power of the locate signal 152 by electronic amplification and other similar methods. The relayed locate signal 154 should be powerful enough to be transmitted to the satellite communication station 110. The monitoring station 108 can transmit the relayed locate signal 154 with the unique code by electromagnetic signals, such as, but not limited to, radiofrequency waves or by cellular phone signals, such as, but not limited to, email, SMS message, EMS message, MMS message, and other similar signals. The monitoring station 108 may be a station specifically provided for the system, a third-party relaying service, or any other similar mechanism for relaying a nearby signal to a distant receiver. Preferably, the monitoring station 108 is located where a cell phone signal can be sent from the monitoring station 108 to the satellite communication station 110.

Upon receiving the relayed locate signal 154 with the unique code, the satellite communication station 110 transmits an initiate search signal 156 with the unique code to the satellites 112. The satellite communication station 110 receives the relayed locate signal 154 and transmits the initiate search signal 156. The initiate search signal 156 is preferably an electromagnetic signal, such as, but not limited to, radiofrequency waves or a cellular phone signal, such as, but not limited to, email, SMS message, EMS message, MMS message, and other similar signals. The satellite communication station 110 may be near the monitoring station 108. The satellite communication station 110 can also be a part of the monitoring station 108.

The satellites 112 are placed in orbit around the Earth. When the satellites 112 receive the initiate search signal 156 with the unique code, preferably three of the satellites 112 transmit a search signal 158. The satellites 112 transmit the search signal 158 by electromagnetic emissions or other suitable methods. The search signal 158 is transmitted over a search area of predetermined size to locate the chip 104 with the unique code 102 received by the satellites 112. Preferably, the search area initially has a diameter of five miles. When the chip 104 receives the search signal 158, it preferably transmits a response signal back to the satellite communication station 110 thru satellite 112 which then knows that chip 104 has been located in the location to which the respective satellite was transmitting. For instance, the satellite 112 adds its own identifying information to the response signal from the chip 104. If the chip 104 with the unique code 102 received by the satellites 112 is not located in the initial search area, then at least one satellite 112 incrementally expands the search area of the search signal 158. Preferably, programming of the satellite 112 causes it to incrementally expand the search area.

The unique code 102 is located when the search signal 156 makes electronic contact with the unique code 102. The search signal 156 can make electronic contact with the unique code 102 when the chip 104 receives the search signal 156. Alternatively, electronic contact with the unique code 102 can be made when the chip 104 sends a signal in response to the search signal 156.

If the chip 104 with the unique code 102 received by the satellites 112 is still not located in the search area, then the satellites 112 continue to incrementally expand the search area after each set of sweeps until the appropriate chip 104 is located. The satellites 112 can be programmed to expand the search area after a predetermined number of sweeps. Preferably, upon completing ten sweeps of the initial search area without finding the chip 104, the diameter of the search area is increased from five miles to ten miles. If the chip 104 is still not located after another set of sweeps, then the diameter of the search area is preferably incrementally increased to fifteen miles, twenty miles, fifty miles, and one hundred miles until the chip 104 is located. If the chip 104 is still not located, then instructions can be sent to the satellites 112 to expand the search area even further.

When one of the satellites 112 locates the chip 104 with the unique code 102 received by the satellites 112, that satellite 112 communicates the location of the chip 104 to at least two other satellites 112. Communication between satellites 112 is by electromagnetic transmissions or other suitable methods. The at least two other satellites 112 direct their search signals 158 substantially near the location of the chip 104 with that unique code 102. The satellites 112 are preferably programmed to direct their search signals 158 towards the location of the chip 104 upon receipt of the location of the chip 104. Based on the angles of the search signals 158, triangulation data 157 is formed. The triangulation data 157 is preferably formed from the angles of the search signals 158 relative to the satellites 112 or other suitable reference. Preferably, the triangulation data 157 is formed by software on the satellite. Afterwards, the satellites 112 transmit triangulation data 157 for the chip 104 with the unique code 102 received by the satellites 112 to the satellite communication station 110. The satellite communication station 110 forms location data 160 from the triangulation data 157. Preferably, a computer located near or in communication with the satellite communication station 110 forms the location data 160 from the triangulation data 157. Also, the location data 160 preferably includes a longitude and a latitude of the location of the chip 104 with the unique code 102.

The satellites 112 may be manufactured specifically for use with the system 100, or existing satellites may be leased for the system 100. Alternatively, a transceiver portion of an existing satellite can be used. The transceiver portion would be programmed to transmit the search signal 158 upon receiving the initiate search signal 156 with the unique code 102 and to expand the search area of the search signal 158 until the chip 104 with the matching unique code 102 is located. The transceiver portion would also be programmed to send triangulation data 157 once the chip 104 with the matching unique code 102 is located.

The satellite communication station 110 sends the location data 160 to the monitor 106 with the matching unique code 102. The satellite communication station 110 can send the location data 160 to the monitor 106 by electromagnetic signals, such as, but not limited to, radiofrequency waves or by cellular phone signals, such as, but not limited to, email, SMS message, EMS message, MMS message, and other similar signals. Because of the unique code 102 electronically disposed in the monitor 102, the satellite communication station 110 sends the location data 160 to the appropriate monitor 106.

After receiving the location data 160, the monitor 106 displays the location data 160. Preferably the location data 160 is displayed on a map on the display device 105. The location data 160 may be displayed as merely the longitude and latitude of the chip 104, an arrow pointing in the direction of the chip 104 with a distance to the chip 104, or another suitable method for leading the user to the chip 104 with the unique code 102 on the display device 105.

The satellite communication station 110 then transmits the location data 160 to the monitoring station 108. The location data 160 can be transmitted by electromagnetic signals, such as, but not limited to, radiofrequency waves or by cellular phone signals, such as, but not limited to, email, SMS message, EMS message, MMS message, and other similar signals.

The monitoring station 108 then relays the location data 160 to the monitor 106. The monitoring station 108 transmits the location data by electromagnetic signals, such as, but not limited to, radiofrequency waves or cellular phone signals, such as, but not limited to, email, SMS message, EMS message, MMS message, and other similar signals.

Referring to FIG. 2, a flow diagram showing a method for locating an individual is shown. First, a unique code 102 is assigned to a chip 104, step 202. Then, the chip 104 is implanted in the individual, step 204. Next, a monitor 106 is provided with the unique code 102, step 206. The monitor 106 is capable of transmitting a locate signal 152 with the unique code when a user wants to locate the individual. Next, a monitoring station 108 in communication with the monitor 106 is provided, step 208. The monitoring station 108 transmits a relayed locate signal 154 with the unique code after receiving the locate signal 152 with the unique code from the monitor 106. Next, a satellite communication station 110 is provided, step 210. The satellite communication station 110 is in communication with the monitoring station 108 and can transmit an initiate search signal 156 after receiving the relayed locate signal 154. Next, satellites 112 in communication with the satellite communication station 110 are provided, step 212.

Each of the satellites 112 transmits a search signal 158 within a search area of predetermined size after receiving the initiate search signal 156 with the unique code. Each of the satellites 112 is programmed to increase the search area until the chip 104 with the corresponding unique code 102 is located. Preferably, the search area initially has a diameter of five miles. Upon completing a predetermined number of sweeps of the initial search area without finding the chip 104, the diameter of the search area is increased. Preferably, the diameter of the search area is increased from five miles to ten miles. If the chip 104 is still not located after another set of sweeps, then the diameter of the search area is preferably incrementally increased to fifteen miles, twenty miles, fifty miles, and one hundred miles after each set of sweeps until the chip 104 is located. If the chip 104 is still not located, then instructions can be sent to the satellites 112 to expand the search area even further.

Next, triangulation data 157 is formed from the search signals 158, step 214. Then, location data 160 is formed from the triangulation data 157, step 216, and the location data 160 is transmitted to the monitor 106 with the unique code 102, step 218. Finally, the location data 160 is displayed on the monitor 106, step 220.

As apparent from the above description, the present invention provides a system and a method for locating an individual. The system and the method operates an expansive area for searching because satellites orbiting overhead can search a large search area. Also, the system and method uses readily available parts such as, but not limited to, cellular phones, PDA's, MMS messages, and pre-existing satellites.

While a particular embodiment has been chosen to illustrate the invention, it will be understood by those skilled in the art that various changes and modifications can be made therein without departing from the scope of the invention as defined in the appended claims.

What is claimed is:

1. A system for locating an individual, comprising:
a chip with a unique code, the chip associated with the individual;
a monitor with the unique code, the monitor transmitting a locate signal with the unique code and receiving location data;
a satellite communication station in communication with the monitor, the satellite communication station receiving the locate signal with the unique code and thereafter transmitting an initiate search signal with the unique code; the satellite communication station forming the location data after receiving triangulation data and transmitting the location data to the monitor; and
a plurality of satellites in communication with the satellite communication station, each of the plurality of satellites capable of transmitting a search signal upon receiving the initiate search signal with the unique code, the search signal being transmitted over a search area of predetermined size to locate the chip with the unique code received by the satellites, the search signal increasing the search area until the chip with the unique code received by the satellites is located;
wherein the search signals from the plurality of satellites form the triangulation data.

2. The system for locating an individual according to claim 1, wherein the monitor communicates with the monitoring station by cellular phone signal.

3. The system for locating an individual according to claim 1, wherein the location data is a longitude and latitude of the chip.

4. The system for locating an individual according to claim 1, wherein a plurality of maps is provided in the monitor.

5. The system for locating an individual according to claim 4, wherein the location data is displayed on a map stored in the monitor.

6. The system for locating an individual according to claim 1, further comprising a monitoring station in communication with the monitor, the monitoring station receiving the locate signal with the unique code and thereafter transmitting a relayed locate signal with the unique code to the satellite communication station.

7. A method of locating an individual, comprising the steps of:
assigning a unique code to a chip;
implanting the chip in the individual;
providing a monitor with the unique code, the monitor capable of transmitting a locate signal with the unique code when a user wants to locate the individual;
providing a satellite communication station in communication with the monitor, the satellite communication station capable of transmitting an initiate search signal with the unique code after receiving the locate signal with the unique code;
providing a plurality of satellites in communication with the satellite communication station, each of the plurality of satellites capable of transmitting a search signal after receiving the initiate search signal with the unique code, the search signal being transmitted over a search area of predetermined size to locate the chip with the unique code received by the satellites, each of the plurality of satellites programmed to increase the search area until the chip is located;
forming triangulation data from the search signals;
forming location data from the triangulation data;
transmitting the location data to the monitor; and
displaying the location data on the monitor.

8. The method of locating an individual according to claim 7, wherein the monitor communicates with the monitoring station by cellular phone signal.

9. The method of locating an individual according to claim 7, wherein the location data is a longitude and latitude of the chip.

10. The method of locating an individual according to claim 7, further comprising the step of storing a plurality of maps in the monitor.

11. The method of locating an individual according to claim 10, further comprising the step of displaying the location data on one of the plurality of maps stored in the monitor.

12. The method of locating an individual according to claim 7, further comprising the step of providing a monitoring station in communication with the monitor, the monitoring station transmitting a relayed locate signal with the unique code to the satellite communication station after receiving the locate signal with the unique code.
